(19) United States
(12) Patent Application Publication
(10) Pub. No.: US 2012/0160235 A1
(43) Pub. Date: Jun. 28, 2012

(54) SPACE FRAME FOR A SOLAR COLLECTOR

(75) Inventors: Dan Terry, Woodinville, WA (US); Steve Terry, Woodinville, WA (US); Mark Turley, Litchfield Park, AZ (US)

(73) Assignee: ACCIONA SOLAR POWER, INC., Henderson, NV (US)

(21) Appl. No.: 12/976,574

(22) Filed: Dec. 22, 2010

(51) Int. Cl. F24J 2/52; B21D 53/02; F16M 13/00

(52) U.S. Cl. 126/696; 211/182; 29/890.033

(57) ABSTRACT

Space frames incorporating flanged chords and struts with receiving spaces configured to receive at least portions of the chord flanges without the need for connector nodes that are separate from the chords. For example, a space frame can include a strut, a first chord, and a second chord. The first chord can have a first flange and a second flange fixed relative to the first flange. The second chord can have a third flange. The strut can include receiving spaces configured to receive portions of the first flange and the third flange. The strut can be secured relative to the first and second chords and the space frame can support a reflective surface configured to focus electromagnetic radiation.

### BACKGROUND

1. Field of the Inventions

The present inventions relate to frames, such as space frames that can be incorporated in solar collector systems and methods for making such structures.

2. Description of the Related Art

With finite amounts of fossil fuels stored in the Earth's crust, significant efforts have been spent to develop cost-effective renewable energy solutions. Amongst these efforts, harvesting the sun's radiation energy represents a promising solution. Heat energy harnessed from the sun can be converted into electric power or can be stored for other uses.

Initially, in an attempt to capture such heat energy from solar rays, solar collecting systems employed large flat surface materials conducive to the absorption and storage of heat. For unobstructed exposure to solar rays, these surface materials were typically positioned and secured on top of buildings or facilities where the captured heat could be used immediately or stored for future use.

Improvements within the solar energy field introduced the reflection of solar rays onto smaller surfaces, intensely concentrating and focusing the solar rays for more efficient heating. A parabolic structure, when used as a reflective surface, directs and/or reflects rays through one point or focal zone. If positioned correctly in relation to the sun, many rays can pass through a predetermined point or linear zone within the inner area of the parabolic reflective surface.

Responding to these solar energy discoveries and improvements, the market introduced various stationary parabolic reflective troughs. Solar rays reflect off the surface of the parabolic trough, focusing onto a fluid-filled conduit which lies along the trough's focal point. The working fluid flowing through this conduit can be used to heat water into steam, which can be used to rotate a turbine and create electricity. These parabolic reflective troughs can be supported by one or more space frames.

### SUMMARY OF THE INVENTIONS

The devices, systems, and methods disclosed herein each have several aspects, no single one of which is solely responsible for their desirable attributes. Without limiting the scope of the inventions, certain prominent features are discussed briefly below. After considering this discussion, and particularly after reading the section entitled “Detailed Description of Certain Embodiments,” one will understand how the features of the devices, systems, and methods disclosed herein provide advantages over other known devices, systems, and methods.

An aspect of at least one of the inventions disclosed herein includes the realization that directly connecting chords to one or more struts in a space frame for a solar collector system can overcome certain problems. For example, existing space frames used to support one or more reflective surfaces in a solar collector system include node connectors that are placed on chords. To fix one or more struts relative to the chords, the struts can be secured to the node connectors. Disposing node connectors between chords and struts complicates the manufacture and assembly of space frames and often results in deviations from the desired space frame characteristics or specifications.

Thus, in accordance with at least some of the embodiments disclosed herein, struts are provided with receiving spaces that receive portions of associated flanges on chords. In this way, struts can be fixedly coupled to one or more chords without disposing traditional node connectors therebetween. In some embodiments, the receiving spaces can be at least partially defined by tooth and bite structures and the tooth and bite structures can optionally be secured relative to the associated flanges by one or more pin connections. Therefore, connections between the struts and chords can be made quickly and easily.

In accordance with other embodiments, a space frame can include a first strut, a first chord, and a second chord. The first strut can have a first receiving space and a second receiving space. The first chord can have a first flange disposed at least partially within the first receiving space and can also include a second flange fixed relative to the first flange. In some embodiments, the second flange can extend away from the first flange. The second chord can have a third flange disposed at least partially within the second receiving space. In some embodiments, the first chord can be secured relative to the first strut and the second chord can be secured relative to the first strut such that the first chord and the second chord are secured relative to one another.

In accordance with other embodiments, a method of manufacturing a space frame for a solar collector is disclosed. The method can include providing a first strut having a first receiving space and a second receiving space. The method can also include providing a first chord having a first flange and a second flange fixed relative to the first flange, and providing a second chord having a third flange. At least a portion of the first flange can be disposed within the first receiving space and at least a portion of the third flange can be disposed within the second receiving space.

According to other embodiments, a space frame includes, at least, a first strut, a second strut, and a first chord. The first strut can extend in a first direction and have a first receiving space and a second receiving space. The second strut can extend in a second direction and can have a third receiving space and a fourth receiving space. The first chord can extend in a third direction and can have at least a first flange and a second flange fixed relative to the first flange. The first flange can be at least partially disposed within the first receiving space and the second flange can be disposed at least partially within the third receiving space. The first chord can be fixed relative to the first strut and the second strut.

### BRIEF DESCRIPTION OF THE DRAWINGS

Throughout the drawings, reference numbers can be re-used to indicate correspondence between referenced elements. The drawings are provided to illustrate embodiments of the inventions described herein and not to limit the scope thereof.

FIG. 1 schematically illustrates an embodiment of a solar collector system in the context of an abstract solar plant.

FIG. 2 schematically illustrates an embodiment of a solar power plant including a plurality of solar collector systems.

FIG. 3 schematically illustrates a perspective view of an embodiment of a solar collector system including a space frame.

FIG. 4 schematically illustrates a side view of the solar collector system of FIG. 3 shown without the lateral structure.

FIGS. 4A-4C schematically illustrate close-up views of portions of the solar collector system of FIG. 4.

FIG. 5 schematically illustrates a perspective view of the space frame of FIGS. 3 and 4.

FIG. 6A schematically illustrates a perspective view of a portion of an embodiment of an elongated body configured to be incorporated in a space frame strut.

FIG. 6B schematically illustrates a perspective view of an embodiment of a plug configured to be incorporated in a space frame strut.

FIG. 6C schematically illustrates a side view of the plug of FIG. 6B.

FIG. 6D schematically illustrates an embodiment of a pin.

FIG. 6E schematically illustrates an exploded view of one end of an embodiment of a space frame strut including the elongated body of FIG. 6A, the plug of FIGS. 6B and 6C, and the pin of FIG. 6D.

FIG. 7 schematically illustrates the space frame strut of FIG. 6E secured to a flange of a space frame chord.

### DETAILED DESCRIPTION OF CERTAIN EMBODIMENTS

Embodiments disclosed herein relate to frames, such as but without limitation, space frames that can include struts and chords that are secured to one another without the use of a separate node connector. The chords can include flanges that extend in various directions and the struts can include receiving spaces that receive portions of the chord flanges. In this way, the chords and struts can be secured together using various fasteners (e.g., bolts and/or pins) without requiring a separate node connector therebetween. In some embodiments, the struts can include teeth and bite structures that at least partially define the receiving spaces. These teeth and bite structures can be secured relative to a chord flange by one or more pins. In this way, the space frames disclosed herein can be built in less time, can be less expensive to manufacture, and can be assembled with fewer deviations from the desired result than existing space frames.

As used herein, a “space frame” is a network of structural framing members that can be used to support another element or structure, for example, a reflective surface used to focus electromagnetic radiation (e.g., sunlight) in a solar power plant. In some embodiments, space frames can include a plurality of chords that extend along a longitudinal length of the space frame and can also include one or more struts that couple the chords to one another and provide structural support to the space frame.

Existing space frames can include node connectors that are disposed between the chords and struts to couple the chords relative to the struts. Accordingly, a node, or region of a space frame where a chord is coupled to at least one strut, can include a portion of a chord, a node connector secured relative to the chord, and a portion of one or more struts secured relative to the node connector such that the one or more struts are indirectly secured to the chord by the node connector.

Space frames including one or more node connectors can require complex and/or lengthy manufacturing or assembly processes. For example, in some processes, a chord is first provided, a node connector is aligned on a portion of the chord, the node connector is secured relative to the chord in the proper alignment, a strut is then provided, the strut is aligned relative to the node connector, the strut is secured relative to the node connector in the proper alignment, and these steps must be repeated to connect each of the struts to their corresponding chords. Thus, manufacturing and/or assembling space frames in accordance with what is known in the art can be time intensive, can require highly skilled laborers, and can result in deviations from the properties (e.g., structural and/or aesthetic properties) desired in the resulting space frame.

Throughout the drawings, reference numbers can be re-used to indicate correspondence between referenced elements. The drawings are provided to schematically illustrate some of the embodiments of the various inventions described herein and are not provided to limit the scope thereof.

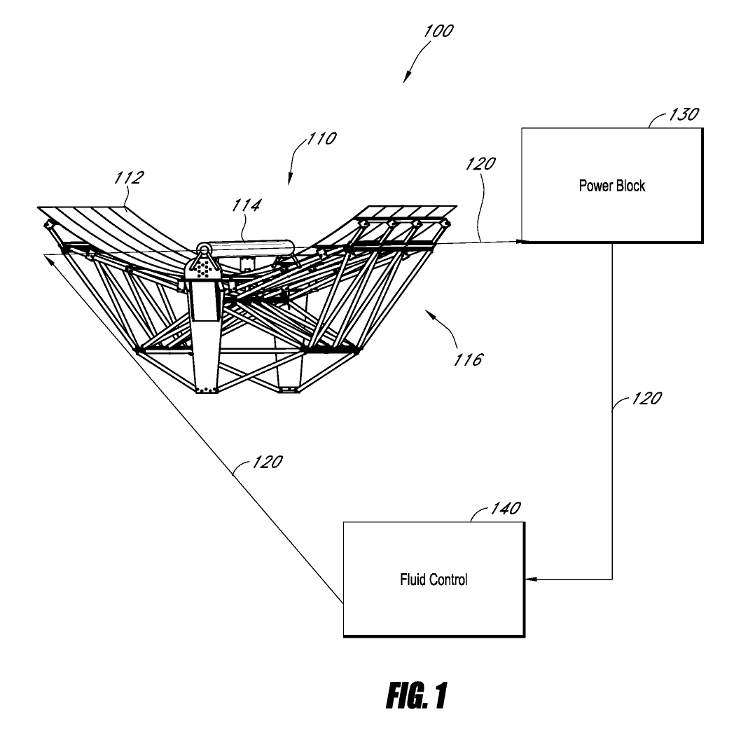

FIG. 1 schematically illustrates an embodiment of a solar collector system 110 in the context of a solar plant 100. The solar collector system 110 can include one or more space frames 116 and reflective surfaces 112 supported by the space frame 116. As illustrated in FIG. 1, where the solar collector system 110 is configured to concentrate solar energy, the reflective surface 112 can be substantially parabolic and configured to reflect and focus electromagnetic radiation (e.g., sunlight) on a focal zone 114. A person having ordinary skill in the art will understand that in other embodiments the reflective surface 112 can be differently shaped and the location of the focal zone 114 relative to the reflective surface 112 can vary depending on the shape of the reflective surface 112.

The solar plant 100 can also include a series of pipes or conduits 120 that form a closed-loop fluid circulation system for a working fluid, for example, oil. In this way, a working fluid can pass from the solar collector system 110 through a pipe 120, or series of pipes 120, to a power block 130 for transferring heat to another working fluid, such as water, for power generation. From the power block 130, the working fluid may pass through another pipe 120, or series of pipes 120, to a fluid control module 140. From the fluid control module 140, the working fluid may pass through another pipe 120, or series of pipes 120, back to the solar collector system 110. A person having ordinary skill in the art will understand that additional components, for example, re-heating or heat transfer systems, can also be included in the closed-loop fluid circulation system.

With continued reference to FIG. 1, one or more pipes 120 can extend or pass through at least a portion of the focal zone 114. In this way, the reflective surface 112 can direct and/or reflect electromagnetic radiation to the pipe 120 in order to heat the working fluid flowing through the solar plant 100. The heated working fluid can flow from the focal zone 114 to the power block 130. The power block 130 can include one or more heat exchangers to transfer thermal energy from the working fluid to a second working, for example water as noted above, to vaporize the second working fluid. The vaporized second fluid can subsequently be directed through a turbine to generate electricity.

As mentioned above, the solar plant 100 can also optionally include a fluid control module 140. The fluid control module 140 can include various components, for example, one or more pumps, that can be used to regulate the flow of the working fluid through the solar plant 100. In some embodiments, the fluid control module 140 can act to increase the flow rate of the working fluid on relatively sunny days and/or can act to decrease the flow rate of the working fluid on days with less sun.

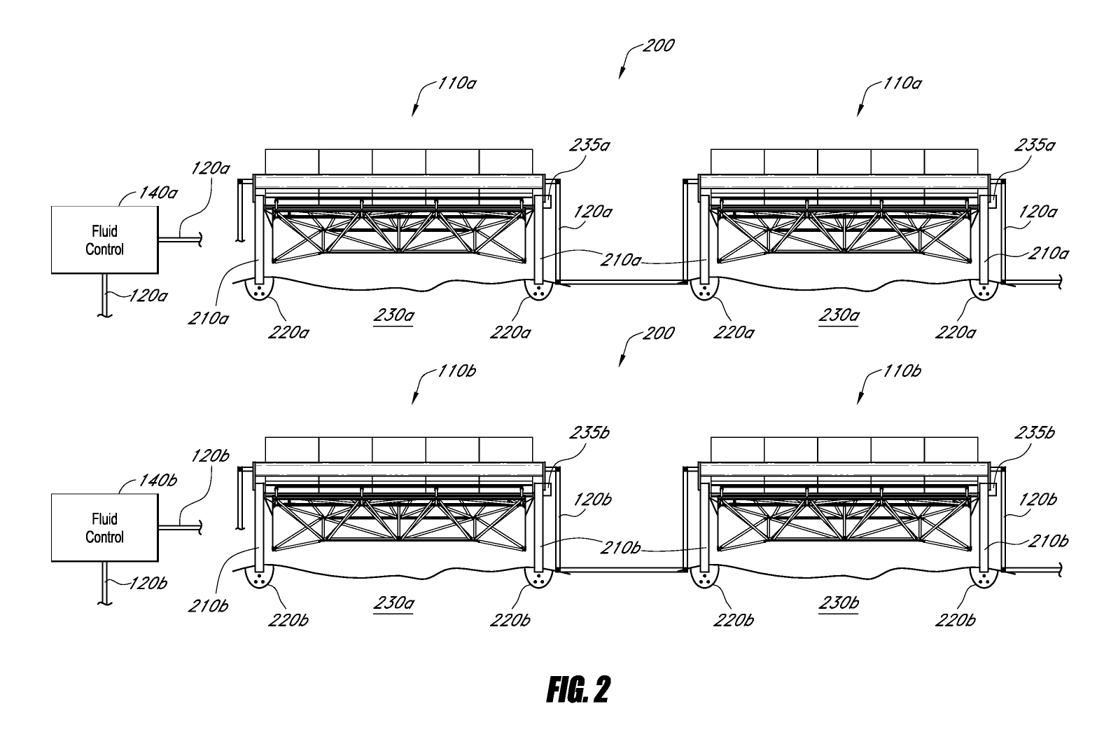

In some embodiments, a solar plant can include one or more fields, and each field can include multiple solar collector systems 110. FIG. 2 schematically illustrates an embodiment of a solar power plant 200 including a plurality of solar collector systems 110. The solar plant 200 includes a first row including a plurality of solar collector systems 110a and includes at least one other row including a plurality of solar collector systems 110b. The solar collector systems 110 of each row are fluidly connected to one another in series by one or more pipes 120. The flow of working fluid through each row of solar collector systems 110 can be monitored by a fluid control module 140 associated with a particular row. As discussed above with reference to FIG. 1, although not illustrated in FIG. 2, heated working fluid that passes through a row of solar collector systems 110 can subsequently be directed to one or more power blocks to convert the thermal energy of the working fluid to electricity.

As schematically illustrated in FIG. 2, each solar collector system 110 can be supported by one or more supports 210. Each support 210 can be secured relative to the ground 230 by a concrete foundation 220. Each foundation 220 can be disposed completely or partially within the ground 230 and each support 210 can extend into the ground 230 and/or beyond its foundation 220. In other embodiments, a solar collector system 110 can be supported by other means, for example, a solar collector system 110 can be disposed directly on the ground 230. However, offsetting a solar collector system 110 from the ground 230 by a transverse distance can allow the solar collector system 110 to move and/or rotate relative to the ground surface.

With continued reference to FIG. 2, each solar collector system 110 can optionally include a drive block 235 configured to rotate the solar collector system 110 relative to a longitudinal axis of the solar collector system 110. In this way, each solar collector system 110 can move during the day such that a reflective surface disposed thereon is exposed to sunlight at a given point in time. The drive blocks 235 can include sensors to control the rotation of each solar collector system 110 and/or can receive instructions for controlling the rotation.

In some embodiments, each solar collector system 110 can include an axle that extends substantially parallel to the longitudinal axis of the solar collector system 110. The drive block 230 can include a motor which can be powered to cause rotation of the axle. Therefore, components fixedly coupled to the axle, for example, a reflective surface and/or space frame, can also be rotated relative to the longitudinal axis of the solar collector system 110. In other embodiments, a solar collector system 110 does not include an axle but can be rotated by one or more drive blocks by virtue of a rotatable connection between the solar collector system 110 and one or more supports 210.

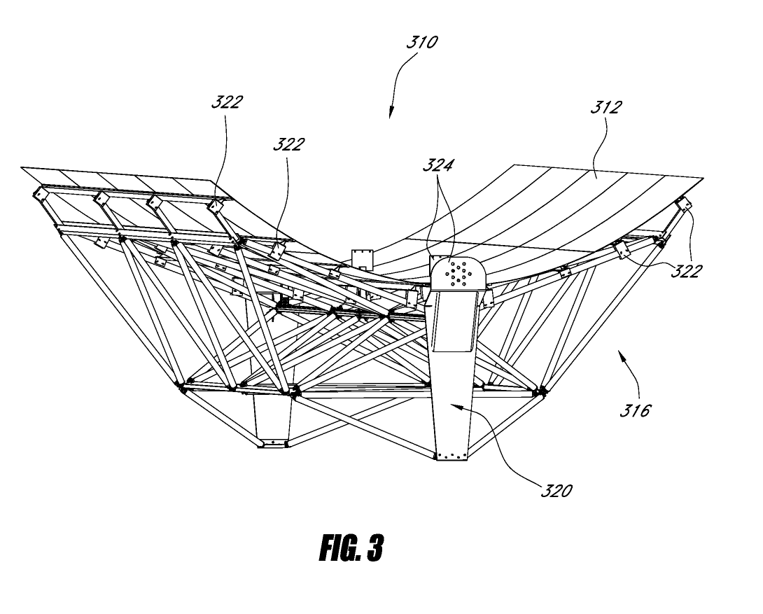

FIG. 3 schematically illustrates a perspective view of an embodiment of a solar collector system 310 including a space frame 316. The space frame 316 can be configured to support one or more reflective surfaces 312. In some embodiments, one or more reflective surfaces 312 can be secured relative to the space frame 316 by one or more connection elements 322. The connection elements 322 can be fastened relative to the space frame 316 using various mechanical fasteners, for examples, nuts and bolts, and can be fastened relative to the one or more reflective surfaces 312 by various mechanical fasteners. Accordingly, movement (e.g., rotation) of the space frame 316 can result in movement of the one or more reflective surfaces 312 and vice versa.

Also included in the solar collector system 310 are optional lateral structures 320, which can be referred to as “torque plates”. The lateral structures 320 can be disposed on opposite longitudinal ends of the solar collector system 310 and can be attached to the space frame 316 using mechanical hardware. The lateral structures 320 can also be coupled or attached to a support, drive block, and/or working fluid pipe. For example, in some embodiments, each lateral structure 320 is rotatably coupled to a support to offset the solar collector system 310 from a ground surface while allowing the solar collector system 310 to rotate relative to the support.

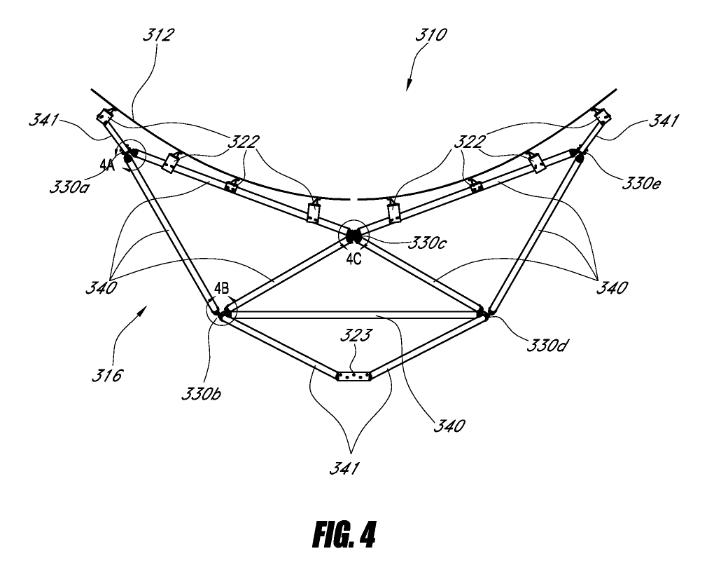

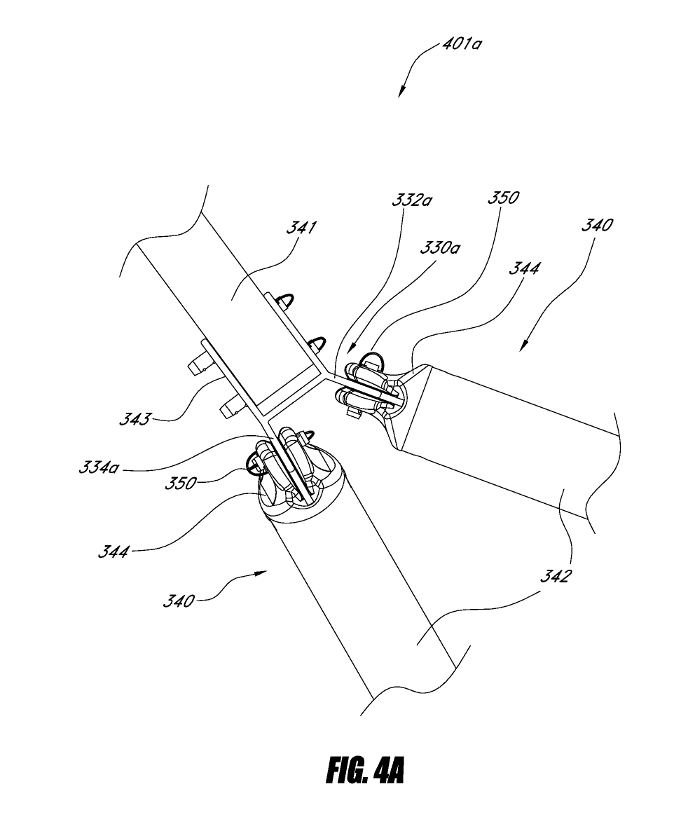

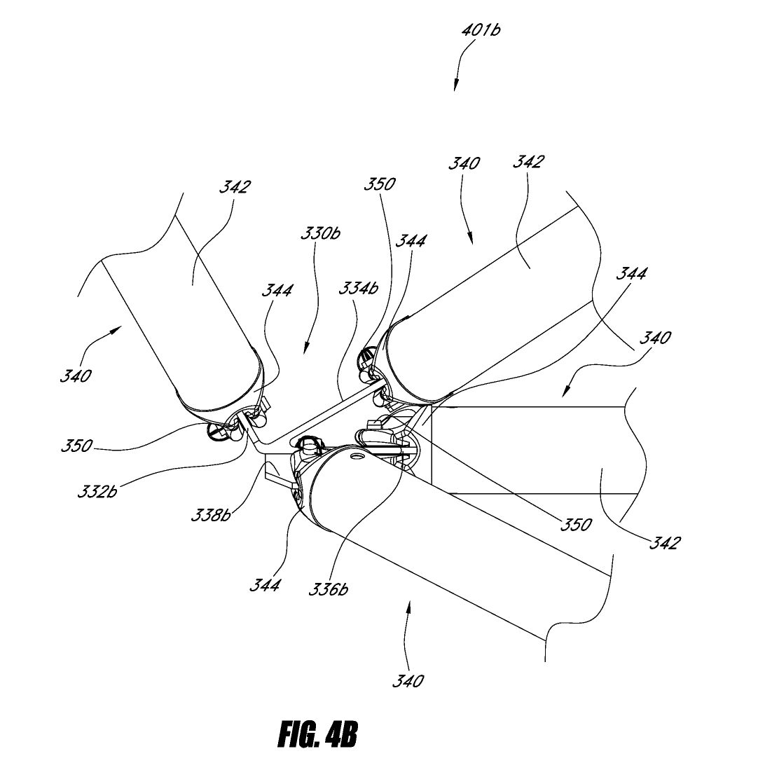

FIG. 4 schematically illustrates a side view of the solar collector system 310 of FIG. 3 shown without the lateral structures 320. As shown, the space frame 316 can include a plurality of chords 330a-e and can also include a plurality of struts 340 connecting the chords 330a-e with one another. The chords 330a-e can extend in various directions relative to the longitudinal axis of the space frame 316. In some embodiments, each chord 330a-e extends substantially parallel to the longitudinal axis of the space frame 316 such that each chord 330a-e extends substantially parallel to each other chord. In some embodiments, the chords 330a-e can have different longitudinal lengths. For example, the upper chords 330a, 330e can have longitudinal lengths that are each about the same and that are longer than a longitudinal length of the central chord 330c. Further, the lower chords 330b, 330d can have longitudinal lengths that are each about the same and that are shorter than the longitudinal length of the central chord 330c. In this configuration, the load of the reflective surface 312 can be supported, at least in part, by each of the chords 330a-e.

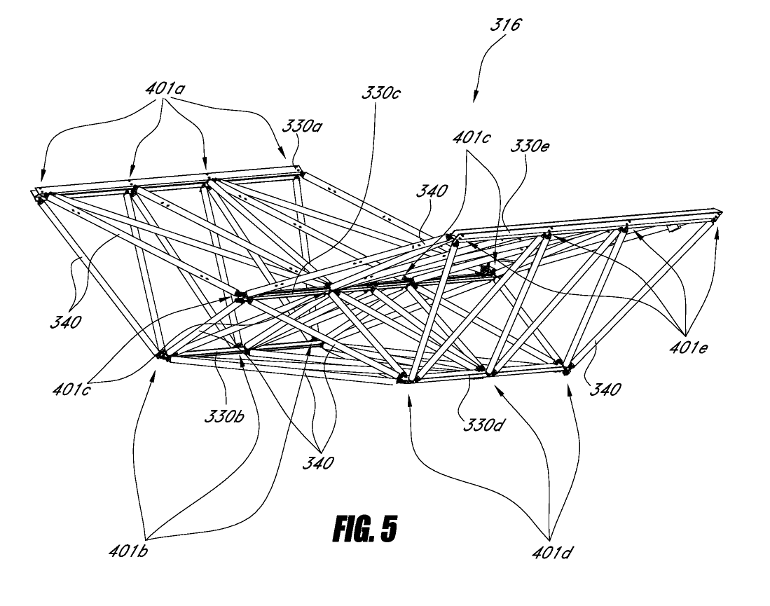

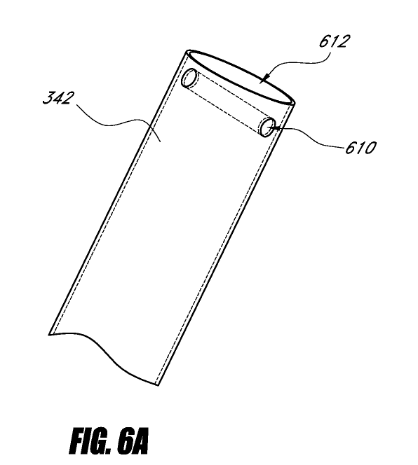

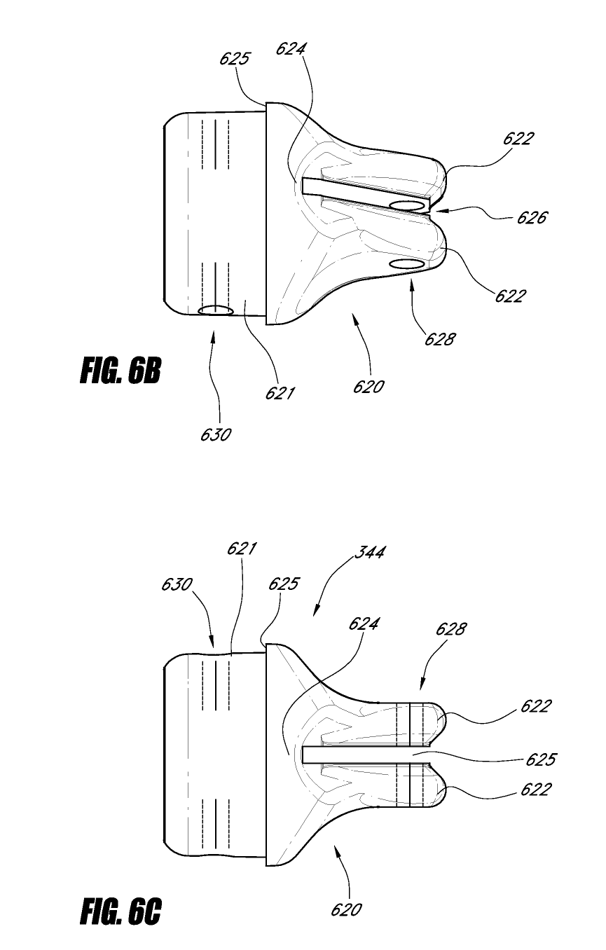

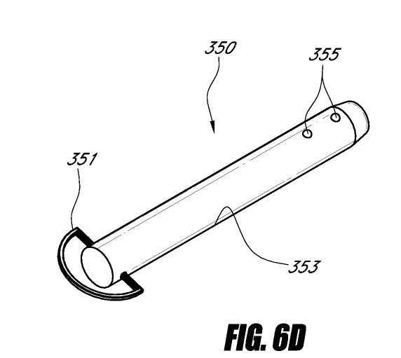

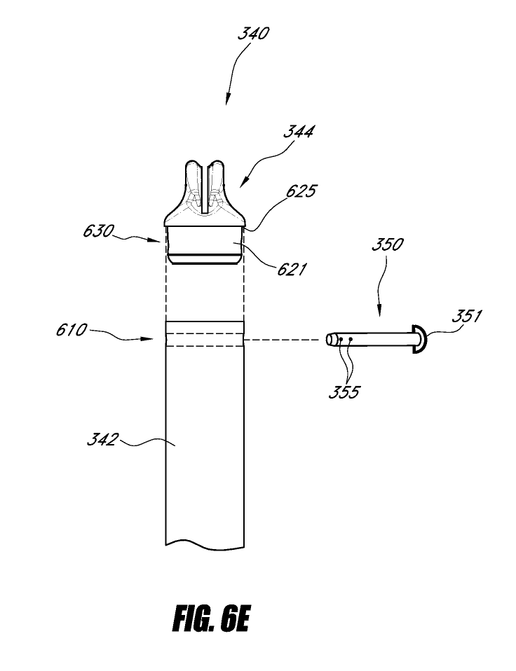

Each of the struts 340 can include at least a first end and a second end disposed opposite to the first end. The first end can be coupled to a first chord 330 and the second end can be coupled to another chord 330. In this way, the struts 340 can interconnect each of the chords 330a-e such that the chords 330a-e and struts 340 form a composite space frame 316. The struts 340 can also act to transfer and/or redistribute a structural load imposed on the space frame 316 (e.g., by wind and/or the weight of the reflective surface 312) amongst the chords 330a-e. As discussed in more detail below with reference to FIGS. 6A-6E, the chords 330a-e can include flanges and the struts 340 can include receiving spaces that receive portions of the chord flanges such that the struts 340 and the chords 330a-e can be secured relative to one another. Accordingly, embodiments of space frames disclosed herein can include struts that are secured relative to chords without the use of traditional node connectors.

Still referring to FIG. 4, the reflective surface 312 can be secured to the space frame 316 by connection elements 322. Some of the connection elements 322 can be secured relative to struts 340 while other connection elements 322 can be secured relative to the space frame 316 by structural members 341 that extend from the upper chords 330a, 330e of the space frame 316. A bottom bracket 323 can be secured relative to a bottom portion of the space frame 316 by structural members 341 that extend from the bottom chords 330b, 330d. The bottom bracket 323 can be used to couple a lateral structure, for example lateral structure 320 of FIG. 3, to the space frame 316.

FIGS. 4A-4C schematically illustrate close-up views of portions of the solar collector system of FIG. 4 including various connection nodes 401. As used herein, a connection node refers to a location on a space frame chord where one or more struts are attached. Although the actual points of attachment of struts to a chord may be discrete and distinct points, for the purposes of engineering analyses, points of attachment that are proximal to one another can be grouped together and treated as a single point at a connection node.

FIG. 4A shows a close-up view of a connection node 401a including chord 330a, struts 340 attached to the chord 330a, and a structural member 341 extending upwardly away from the chord 330a. The chord 330a can include a first flange 332a and a second flange 334a. The first flange 332a can extend in a different direction than the second flange 334. In some embodiments, the flanges 332a, 334a can be fixed relative to one another and in some embodiments, the flanges 332a, 334a are integral with one another.

The chord 330a can also include a bracket 343 that is configured to receive at least a portion of the upwardly extending structural member 341. The structural member 341 can be secured relative to the bracket 343 by various mechanical hardware, for example, nuts and bolts. As discussed above with reference to FIG. 4, the upwardly extending structural member 341 can be coupled to one or more connection elements 322 in order to couple the reflective surface 312 to the space frame 316.

With continued reference to FIG. 4A, each strut 340 can be coupled to one of the flanges 332a, 334a and each strut 340 can extend in a direction that is substantially collinear with a direction that the associated flange 332a, 334a extends in. Each strut 340 can include an elongated body member 342 and plugs 344 disposed partially within the elongated body member 342. As discussed in more detail below, the plugs 344 can include receiving spaces that receive portions of the flanges 332a, 334a and the plugs 344 can be secured relative to the flanges 332a, 334a by pins 350. Further, the plugs 344 can be secured relative to the elongated body member 342 they are disposed partially within by pins (not shown). In this way, the struts 340 are secured relative to the chord 330a. Thus, the connection node 401a includes specific attachment locations between struts 340 and the chord 330a on different flanges 332a, 334a.

Turning now to FIG. 4B, a close-up view of a connection node 401b is shown. Connection node 401b includes chord 330b and struts 340 attached to the chord 330b. The chord 330b can include a first flange 332b, a second flange 334b, a third flange 336b, and a fourth flange 338b. Each flange 332b, 334b, 336b, 338b can extend in a different direction from each of the other flanges. As with the flanges 332a, 334a discussed above with reference to FIG. 4A, each flange 332b, 334b, 336b, and 338b can be fixed relative to each other flange and in some embodiments, the flanges 332b, 334b, 336b, 338b can be integral with one another.

Still referring to FIG. 4B, each strut 340 can be coupled to one of the flanges 332b, 334b, 336b, 338b and each strut 340 can extend in a direction that is substantially collinear with a direction that the associated flange 332b, 334b, 336b, 338b extends in. As discussed above, the struts 340 can be secured relative to the chord 330b by virtue of the interengagement of the plugs 344, flanges 332b, 334b, 336b, 338b, and pins 350.

Turning now to FIG. 4C, a close-up view of a connection node 401c is shown. Connection node 401c includes chord 330c and struts 340 attached to the chord 330c. The chord 330c can include a first flange 332c, a second flange 334c, a third flange 336c, and a fourth flange 338c. Each flange 332c, 334c, 336c, 338c can extend in a different direction from each of the other flanges. As with the flanges 332a, 334a discussed above with reference to FIG. 4A, each flange 332c, 334c, 336c, 338c can be fixed relative to each other flange and in some embodiments, the flanges 332c, 334c, 336c, 338c can be integral with one another.

Still referring to FIG. 4C, each strut 340 can be coupled to one of the flanges 332c, 334c, 336c, 338c and each strut 340 can extend in a direction that is substantially collinear with a direction that the associated flange 332c, 334c, 336c, 338c extends in. As discussed above, the struts 340 can be secured relative to the chord 330b by virtue of the interengagement of the plugs 344, flanges 332c, 334c, 336c, 338c, and pins 350.

As shown in FIGS. 4-4C each chord 330 can include one or more flanges. In some embodiments, the flanges can radiate from a longitudinal axis of the chords 330. In other embodiments, the flanges can extend in directions that are not substantially radial to the longitudinal axis of a chord 330. In chords 330 that include multiple flanges, the flanges can extend in different directions from one another. Each of the flanges on a chord 330 can be arranged such that they are substantially coplanar with at least one other flange on a different chord 330. In this way, the struts 340 can extend substantially straight and interconnect two chords 330 by engaging flanges on each chord 330 that are substantially coplanar with one another. For example, flange 332a in FIG. 4A can be substantially coplanar with flange 332c in FIG. 4C such that one or more struts 340 may secure chord 330a relative to chord 330c by engaging flanges 332a and 332c. Similarly, flange 334b in FIG. 4B can be substantially coplanar with flange 334c in FIG. 4C such that one or more struts 340 may secure chord 330b relative to chord 330c.

As previously discussed, a strut in a space frame can extend from a flange on a first chord to a flange on a second chord. However, it will be appreciated that flanges on space frame chords need not extend the entire longitudinal length of a chord, so long as appropriate flanges are present at each connection node used in a given configuration. Thus, in some embodiments each flange on a chord may extend for substantially the entire longitudinal length of the chord and in other embodiments, a flange on a chord may extend for less than the entire longitudinal length of the chord.

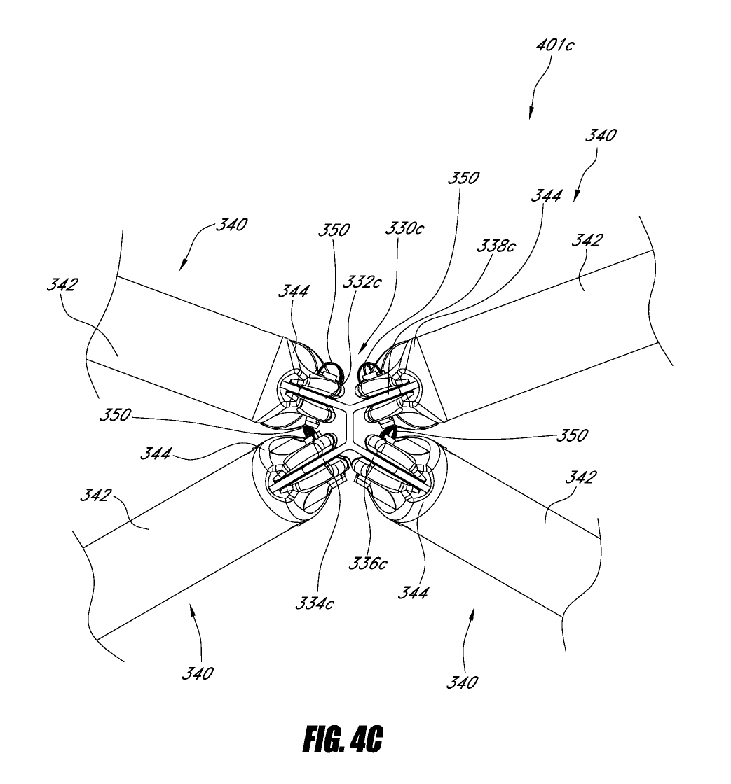

FIG. 5 schematically illustrates a perspective view of the space frame 316 of FIGS. 3 and 4. The space frame 316 can include an upper level defined by upper chords 330a, 330e and a lower level defined by lower chords 330b, 330d. The central chord 330c can be disposed between the upper level and the lower level. The central chord 330c can also be disposed between the left side chords 330a, 330b and the right side chords 330e, 330d.

The upper chords 330a, 330e can be secured relative to the central chord 330c and the lower chords 330b, 330d by one or more struts 340. For example, the upper left chord 330a can be secured relative to the central chord 330c and the lower left chord 330b by struts 340. Similarly, the upper right chord 330e can be secured relative to the central chord 330c and the lower right chord 330d by struts 340. The number of struts 340 connecting the upper chords 330a, 330e to the lower chords 330b, 330b and/or central chord 330c can vary from space frame to space frame. In some embodiments, the number of struts 340 utilized to secure the chords 330 relative to one another is dependent upon structural analyses based on expected loads for the space frame 316. In some embodiments, the upper chords 330a, 330e each include five connection nodes 401a, 401e or locations where one or more struts 340 are secured to the chords 330a, 330e. The connection nodes 401a, 401e can be evenly spaced from one another or irregularly spaced from one another

In some embodiments, each of the lower chords 330b, 330d can be secured relative to the central chord 330c, one of the upper chords 330a, 330c, and the other of the lower chords 330b, 330d by one or more struts 340. For example, the lower left chord 330b can be secured relative to the central chord 330c, the lower right chord 330d, and the upper left chord 330a by struts 340. Also, the lower right chord 330d can be secured relative to the central chord 330c, the lower left chord 330b, and the upper right chord 330e by struts 340. In some embodiments, the lower chords 330b, 330d each include three connection nodes 401b, 401d. The connection nodes 401b, 401d can be evenly spaced from one another or spaced differently.

In some embodiments, the central chord 330c can be secured relative to each of the other chords 330a, 330b, 330d, 330e by one or more struts. The central chord 330c can also include more than one connection node 401c, for example, five connection nodes 401c. The five connection nodes 401c can be evenly spaced from one another or spaced irregularly along the longitudinal length of the central chord 330c. For example, the first connection node 401c and the second connection node 401c can be spaced apart by a first distance, the second connection node 401c and the third connection node 401c can be spaced apart by a second distance, the third connection node 401c and the fourth connection node 401c can be spaced apart by the second distance, and the fourth connection node 401c and the fifth connection node 401c can be spaced apart by the first distance. The first distance can be different than the second distance, for example, the first distance can be greater than the second distance.

Still referring to FIG. 5, the orientation of a strut 340 relative to two chords 330 that the strut 340 connects can vary. For example, a strut 340 can extend substantially normal from each chord 330 that the strut 340 is connected to or a strut 340 can extend at an angle (e.g., not substantially normal) from each chord 330 that the strut 340 is connected to. Accordingly, each chord 330 can include a first strut 340 that extends substantially normal from that chord 330 and at least one other strut 340 that extends from the chord at an angle.

In the embodiments illustrated in the figures, a chord in a space frame can include a flange for each other chord to which it connects to, including zero, one, two, three, four, five, or more flanges. As discussed above with reference to FIG. 4A, chords can also optionally include other structures, for example, brackets, which may be coupled with other components, for example, structural members. Chords can also have unused flanges (e.g., flanges that are not secured to one or more struts) as a result of production decisions whereby it may be efficient to produce a chord with one or more unused flanges instead of designing and producing a chord where all flanges are used.

FIG. 6A schematically illustrates a perspective view of an end portion of an embodiment of an elongated body 342 configured to be incorporated in a space frame strut. While only one end of the elongated body 342 is schematically illustrated in FIG. 6A, the elongated body 342 may include a second end opposite to the illustrated end that is substantially identical to the illustrated end. The elongated body 342 can have various shapes. For example, the elongated body 342 can have circular, square, rectangular, or triangular cross sections. Also, the elongated body 342 can extend linearly along a longitudinal length or can include one or more kinks or turns.

The elongated body 342 can include an aperture 612 configured to receive at least a portion of a plug, for example, the plug 344 discussed below with reference to FIGS. 6B and 6C. In some embodiments, the aperture 612 can provide access to a channel that extends longitudinally through the elongated body 342 such that the elongated body 342 is substantially hollow. In other embodiments, the aperture 612 can provide access to a receiving space that extends for less than the longitudinal length of elongated body 342 such that the elongated body 342 is not completely hollow.

Still referring to FIG. 6A, the elongated body 342 can also include a pair of coaxial apertures 610 that are laterally juxtaposed on opposite sides of the longitudinal axis of the elongated body 342. The apertures 610 can receive a portion of a pin, for example, the pin 350 discussed below with reference to FIG. 6D in order to secure a plug that is received within the elongated body 342 relative to the elongated body 342. In some embodiments, an elongated body 342 may include more than one pair of apertures 610 to receive multiple pins and/or to receive a pin at different locations along the longitudinal axis of the elongated body 342. Additionally, in other embodiments, an elongated body incorporated in a space frame strut can be configured to be received within a plug instead of being configured to receive at least a portion of a plug.

FIGS. 6B and 6C schematically illustrate an embodiment of a plug 344 configured to be incorporated in a space frame strut, for example, struts 340 schematically illustrated in FIG. 5. The plug 344 can include a base portion 621 and a body portion 620 that extends from the base portion 621. In some embodiments, the base portion 621 and the body portion 620 can be separated by an optional shoulder 625 that includes an abutment that is configured to abut an elongated body, for example, the elongated body 342 discussed above.

The base portion 621 of the plug 344 can be configured to fit at least partially within an elongated body of a strut. In some embodiments, the base portion 621 can be sized and/or shaped to fit snugly within the elongated body such that the base portion 621 and the elongated body are held together by an interference fit. The base portion 621 can also include a channel 630 that extends laterally therethrough. As discussed in more detail below with reference to FIG. 6E, the channel 630 can be configured to receive at least a portion of a pin after the base portion 621 has been disposed at least partially within an elongated body in order to secure the plug 344 relative to the elongated body.

FIGS. 6B and 6C schematically illustrate one embodiment of a plug 344. However, other embodiments of plugs can be incorporated in space frame struts. For example, a plug can include a base portion configured to receive a portion of an elongated body. In other embodiments, one or more tongues may extend from a plug and the one or more tongues may be received in corresponding grooves in an elongated body to secure the plug thereto. Additionally, while FIGS. 6A-6E are discussed with reference to one or more pin connections, a variety of other means can be implemented for securing a plug to an elongated body in a space frame. For example, a plug may be fastened to an elongated body using screws, nuts and bolts, welds, adhesives, and/or other means.

With continued reference to FIGS. 6B and 6C, the body portion 620 of the plug 344 can include a pair of teeth 622 that extend parallel or at a skewed angle relative to one another and are offset from one another by a bite portion 624. The teeth 622 and bite portion 624 can at least partially define a receiving space 626 configured to receive at least a portion of a space frame chord, for example, at least a portion of a flange on a chord. Thus, in some embodiments, the distance between the teeth 622 can correspond to the approximate width of the portion of the chord that is to be received therein. For example, the receiving space 626 can be configured to receive a flange having a certain thickness and the distance between the teeth 622 can be about the same as the thickness of the flange. In this way, the teeth 622 can frictionally engage the portion of the space frame chord received therein and provide an interference fit therebetween. A person having ordinary skill in the art will understand that in some embodiments the distance between the teeth 622 is slightly greater than the thickness of a portion of a chord received therein to facilitate the receipt of the portion of the chord by the receiving space 626.

The body portion 620 of the plug 344 can include at least one channel 620 extending through a distal region of both teeth 622. The channel 628 can be configured to receive at least a portion of a pin after a portion of a space frame chord has been received by the receiving space 626. Therefore, the channel 628 can facilitate the securement of the plug 344 to a space frame chord by a pin connection, or some other securement means.

FIG. 6D schematically illustrates an embodiment of a pin 350 including a clip 351 and protrusions 355. In some embodiments, the clip 351 can be used to facilitate the insertion and/or removal of the pin from an aperture or channel and in some embodiments the clip 351 can cause the protrusions 355 to extend from and/or recess within a lateral surface of the body 353 of the pin 350. Other pins can also be used. For example, the self locking pin described in U.S. Pat. No. 6,872,039 can also be used. The description of the self locking pin of U.S. Pat. No. 6,872,039 is hereby expressly incorporated by reference. In some embodiments, an external thread or groove (not illustrated) can be added to the outer surface to further facilitate insertion and fit of the pin.

Pin 350 is an example of a structure that can be used to secure a plug to an elongated body in a space frame strut and/or to secure a space frame strut to a space frame chord. For example, FIG. 6E schematically illustrates an exploded view of an end of a space frame strut 340 including the elongated body 342 of FIG. 6A, the plug 344 of FIGS. 6B and 6C, and the pin 350 of FIG. 6D. As shown, the elongated body 342 can receive the base portion 621 through aperture 612 such that the shoulder 625 of the plug 344 abuts an end of the elongated body 342. The apertures 610 of the elongated body 342 can then be aligned with the channel 630 that extends through the base portion 621 of the plug 344 such that the pin 350 can be inserted therethrough to secure the plug 344 relative to the elongated body 342. The pin 350 can be inserted through the apertures 610 and channel 630 such that the clip 351 and protrusions 355 are juxtaposed on opposite sides of the elongated body 342 and plug 344 to prevent the unintended destruction of the resulting pin connection.

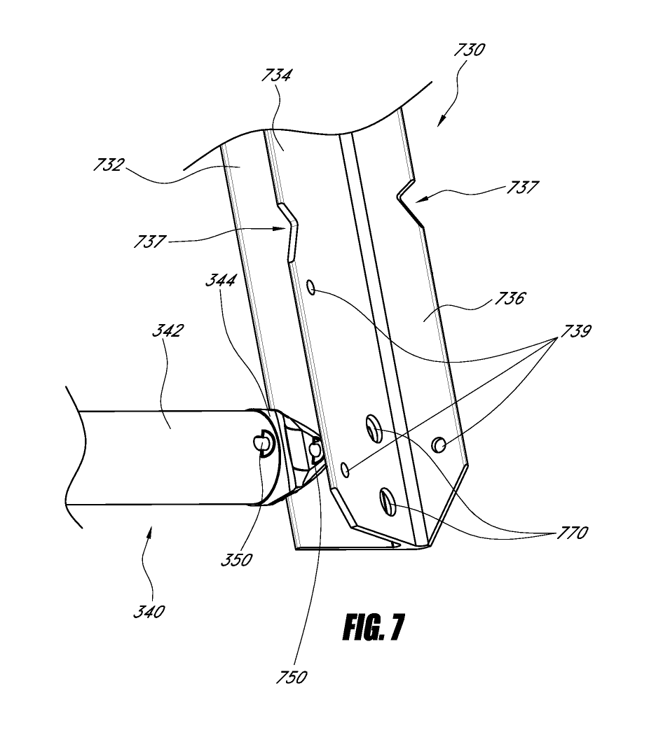

FIG. 7 schematically illustrates the space frame strut of FIG. 6E secured to a flange 732 of a space frame chord 730. The chord 730 may include a first flange 732, a second flange 734, and a third flange 736. Each flange 732, 734, 736 can optionally include one or more apertures 739 to facilitate a pin connection between a strut 340 and the chord 730. As shown, a portion of the first flange 732 can be received within the receiving space 626 (shown in FIGS. 6B and 6C) of the plug 344. The channel 628 (shown in FIGS. 6B and 6C) of the plug 344 can be aligned with an aperture 739 in the first flange 732 and a pin 750 can be inserted through the channel 628 and the aperture 739 resulting in a pin connection that secures the strut 340 relative to the chord 730. In some embodiments, the pin 750 can be identical or similar to the pin 350 used to secure the plug 344 to the elongated body 342 and in other embodiments, pins 750 and 350 can be different from one another. A person having ordinary skill in the art will understand that other means can be used to secure the plug relative to the flange 732. For example, a bolt can be inserted through the channel 628 and aperture 739 and a nut can be used to keep the bolt in such a configuration.

While FIG. 7 schematically illustrates a connection between a single strut 340 and the chord 730, additional struts can optionally be secured relative to the chord 730 with any of the other apertures 739. Alternatively, in some embodiments, a complete space frame may include a quantity of apertures 739 on one or more chords that are not used to facilitate a connection between a strut and the chord. The locations, quantities, sizes, and shapes of the apertures 739 can be chosen depending on the desired characteristics of the resulting space frame. The apertures 739 can be precision punched on an as-needed basis to produce custom chords and/or can be standardized on various standard chords that can be used to construct a variety of space frames.

Flange 734 can also include two additional apertures 770 that are each different in size than the connection apertures 739. These additional apertures 770 can be used to attach structures other than struts to the chord 730. For example, the additional apertures 770 can be used to facilitate the attachment of functional and/or decorative elements, for example, the lateral structure illustrated in FIG. 3, to a space frame.

Chord 730 is also shown including optional notches or cutouts 737 in the second flange 734 and the third flange 736. These notches 737 can allow struts that are secured relative to these flanges 734, 736 to extend away from the chord 730 at a non-perpendicular angle relative to the longitudinal axis of the chord 730. Additionally, notches 737 can also provide additional structure reinforcement for a strut 340 by preventing the rotation of a plug 344 that abuts one or more surfaces within the notch 737 relative to the chord 730.

The foregoing description details certain embodiments of the devices, systems, and methods disclosed herein. It will be appreciated, however, that no matter how detailed the foregoing appears in text, the devices, systems, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which the terminology is associated. The scope of the disclosure should therefore be construed in accordance with the appended claims and any equivalents thereof.

What is claimed is:

1. A space frame for a solar collector, the space frame comprising:
a first strut having a first receiving space and a second receiving space;
a first chord having a first flange disposed at least partially within the first receiving space and a second flange fixed relative to the first flange; and
a second chord having a third flange disposed at least partially within the second receiving space.

2. The space frame of claim 1, wherein the first chord is offset from the second chord along a longitudinal length of the first strut.

3. The space frame of claim 2, wherein the first flange extends along a first plane, wherein the third flange extends along a second plane, and wherein the first plane and the second plane are substantially coplanar.

4. The space frame of claim 3, wherein the second flange extends along a third plane, and wherein the third plane and the first plane are not coplanar.

5. The space frame of claim 4, further comprising:
a second strut having a third receiving space and a fourth receiving space, wherein the second flange is disposed at least partially within the third receiving space; and
a third chord having a fourth flange disposed at least partially within the fourth receiving space.

6. The space frame of claim 5, wherein the third chord is offset from the first chord along a longitudinal length of the second strut.

7. The space frame of claim 6, wherein the fourth flange extends along a fourth plane, and wherein the third plane and the fourth plane are substantially coplanar.

8. The space frame of claim 7, wherein the first strut extends normal to the first chord.

9. The space frame of claim 8, wherein the first strut extends normal to the second chord.

10. The space frame of claim 5, wherein the first chord further comprises a fifth flange, wherein the fifth flange is fixed relative to the first flange.

11. The space frame of claim 10, wherein the first chord further comprises a sixth flange, wherein the sixth flange is fixed relative to the first flange.

12. The space frame of claim 1, wherein the first flange comprises at least one notch.

13. The space frame of claim 12, wherein at least a portion of the at least one notch is disposed within the first receiving space.

14. The space frame of claim 1, wherein the first strut comprises:
an elongated body having a first end and a second end opposite the first end;
a first plug disposed at least partially within the first end, the first plug having a first tooth, a second tooth, and a first bite disposed therebetween, wherein the first receiving space is defined between the first tooth, second tooth, and first bite; and
a second plug disposed at least partially within the second end, the second plug having a third tooth, a fourth tooth, and a second bite disposed therebetween, wherein the second receiving space is defined between the third tooth, fourth tooth, and second bite.

15. The space frame of claim 14, wherein the first plug is secured relative to the elongated body by a first pin.

16. The space frame of claim 15, wherein the second plug is secured relative to the elongated body by a second pin.

17. The space frame of claim 16, wherein the first plug is secured relative to the first flange by a third pin.

18. The space frame of claim 17, wherein the second plug is secured relative to the third flange by a fourth pin.

19. The space frame of claim 1, further comprising a reflective surface configured to focus electromagnetic radiation on a focal zone, wherein the reflective surface is supported at least partially by the first strut.

20. The space frame of claim 19, further comprising at least one connection element disposed between the first strut and the reflective surface, wherein the at least one connection element is secured relative to the first strut and relative to the reflective surface.

21. The space frame of claim 1, wherein the first flange is integral with the second flange.

22. A method of manufacturing a space frame for a solar collector, the method comprising:
providing a first strut having a first receiving space and a second receiving space;
providing a first chord having a first flange and a second flange fixed relative to the first flange;
disposing at least a portion of the first flange within the first receiving space;
providing a second chord having a third flange; and
disposing at least a portion of the third flange within the second receiving space.

23. The method of claim 22, further comprising:
securing the first flange relative to the first strut; and
securing the third flange relative to the first strut.

24. The method of claim 23, further comprising:
providing a second strut having a third receiving space and a fourth receiving space; and
disposing at least a portion of the second flange within the third receiving space.

25. The method of claim 23, further comprising:
providing a third chord having a fourth flange; and
disposing at least a portion of the fourth flange within the fourth receiving space.

26. The method of claim 25, further comprising disposing the first chord and second chord such that the first chord and second chord extend substantially parallel to one another.

27. The method of claim 26, further comprising disposing the first chord and the third chord such that the first chord and the third chord extend substantially parallel to one another.

28. The method of claim 23, further comprising disposing a reflective surface over at least a portion of the first strut.

29. The method of claim 28, further comprising coupling the reflective surface to at least a portion of the first strut.

30. A space frame comprising:
a first strut extending a first direction, the first strut having a first receiving space and a second receiving space;
a second strut extending in a second direction, the second strut having a third receiving space and a fourth receiving space;
a first chord extending in a third direction, the first chord having at least a first flange and a second flange fixed relative to the first flange, the first flange being disposed at least partially within the first receiving space, the second flange being disposed at least partially within the third receiving space, the first chord being fixed relative to the first strut and the second strut.

31. The space frame of claim 30, wherein the first flange extends along a first plane that is substantially parallel to the first direction.

32. The space frame of claim 31, wherein the second flange extends along a second plane that is substantially parallel to the second direction.

33. The space frame of claim 30, wherein the third direction is substantially normal to the first direction.

34. The space frame of claim 30, wherein the third direction is substantially normal to the second direction.

35. The space frame of claim 30, wherein the first and second receiving spaces are each at least partially defined by tooth and bite structures.

36. The space frame of claim 30, further comprising a second chord extending in a fourth direction, the second chord having at least a third flange that is disposed at least partially within the second receiving space, the second chord being fixed relative to the first chord.

37. The space frame of claim 35, wherein the fourth direction is substantially parallel to the third direction.

38. The space frame of claim 35, further comprising a third chord extending in a fifth direction, the second chord having at least a fourth flange that is disposed at least partially within the fourth receiving space, the third chord being fixed relative to the first chord.

39. The space frame of claim 38, wherein the fifth direction is substantially parallel to the third direction.
